(19) United States
(12) Patent Application Publication
(10) Pub. No.: US 2012/0188583 A1
(43) Pub. Date: Jul. 26, 2012

(54) METHOD AND SYSTEM FOR PRINTING

(76) Inventors: Graham Stone, Leek Staffordshire (GB); Fred Heeks, Rawtenstall Lancashire (GB)

(21) Appl. No.: 13/387,449

(22) PCT Filed: Oct. 8, 2010
(86) PCT No.: PCT/EP2010/065123

§ 371 Date: Apr. 12, 2012

(30) Foreign Application Priority Data
Oct. 12, 2009 (GB) 0917801.3

(51) Int. Cl. G06K 15/02

(52) U.S. Cl. 358/1.14

(57) ABSTRACT

According to one aspect of the present invention there is provided a system for printing from a first network to a printer connected to a second network comprising a first server on the first network for receiving a print job, the print job including print code data and user identification data identifying the user on the first network who initiated the print job, the first server configured to transmit the print job over a communication link, a second server on the second network for receiving the print job and user identification data through the communication link, a print server on the second network comprising a database mapping the user identification data of the user on the first network to a user identifier on the second network, and configured to: receive the print job from the second server, receive a request from a printer on the second network to print a print job, the request including an identifier of a user on the second network, identify a received print job associated with the user identifier in the request, and send the identified print job to the printer.

### BACKGROUND

Generally, computer networks, such as enterprise computer networks, provide one or more print servers through which user computing devices connected to the computer network may print documents or appropriate media. Typically, the computer network and print server are on the same network domain.

In organizations or enterprises with high security requirements, such as government, military, defense, and intelligence organizations, such organizations may use multiple separate networks, with each network being independent from the other networks, and each network being used for different classifications of user or use. For example, a government organization may have a ‘top secret’ network, a ‘secret network’, a ‘confidential network’, a ‘restricted network’, and an ‘unclassified’ network.

Currently, in order to be able to print documents from any of an organization's networks each network has to have a separate print server and associated printer or printers. Accordingly, for organizations with multiple independent networks such an arrangement leads to substantial duplication of the printing infrastructure on each of the organization's networks.

### SUMMARY OF THE INVENTION

According to one aspect of the present invention, there is provided a system for printing from a first network to a printer connected to a second network.

The system comprises a first server on the first network for receiving a print job, the print job including print code data and user identification data identifying the user on the first network who initiated the print job. The first server is configured to transmit the print job over a communication link. A second server on the second network is also provided for receiving the print job and user identification data through the communication link. A print server on the second network is also provided which comprise a database mapping the user identification data of the user on the first network to a user identifier on the second network. The print server is configured to receive the print job from the second server, to receive a request from a printer on the second network to print a print job, the request including an identifier of a user on the second network, to identify a received print job associated with the user identifier in the request, and to send the identified print job to the printer.

According to a second aspect of the present invention there is provided a method of printing from a first network to a printer connected to a second network. The method comprises receiving, at a processor, a print job, the print job including print code data and data identifying a user on the first network, transmitting, by the processor, the print job over a communication link. The method further comprises, at a print server on a second network, receiving the print job from the second server through the communication link, receiving a request, from a printer on the second network, to print a print job, the request including an identifier of a user on the second network, identifying, using a mapping database, a received print job associated with the user identified in the received request, and sending the identified print job to the printer.

### BRIEF DESCRIPTION

Embodiments of the invention will now be described, by way of non-limiting example only, with reference to the accompanying drawings, in which:

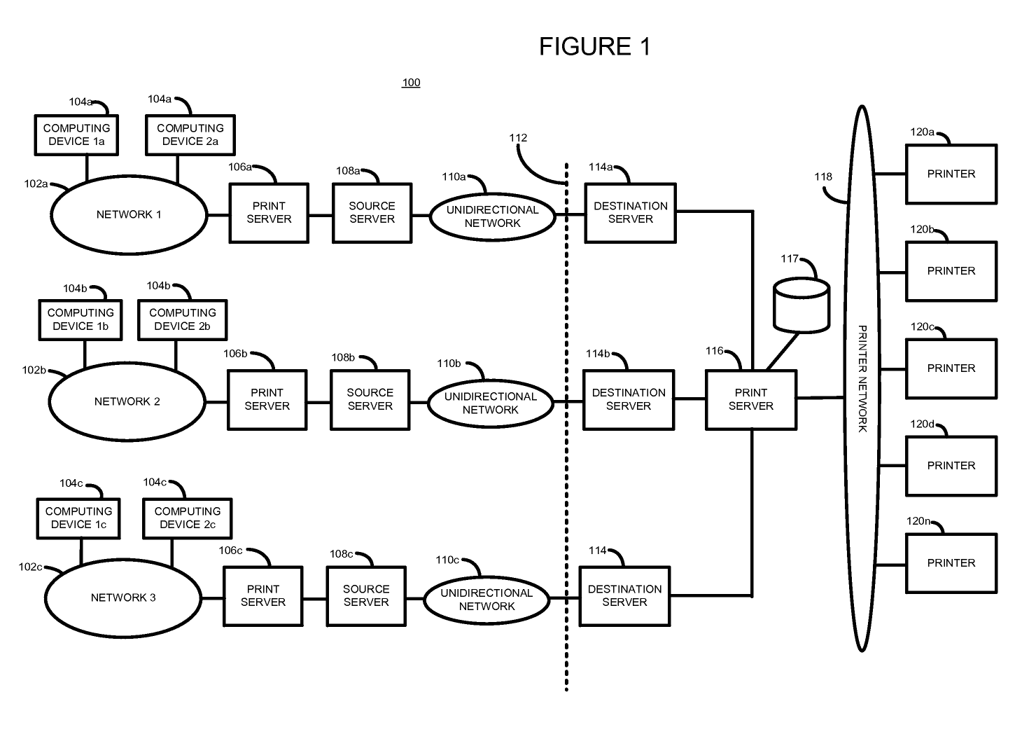

FIG. 1 is a block diagram showing a system according to one embodiment of the present invention;

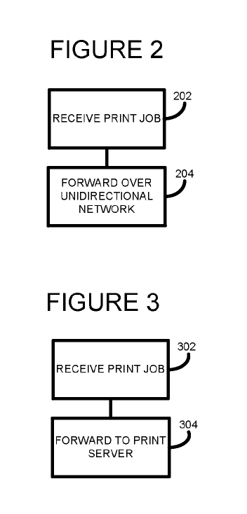

FIG. 2 is a flow diagram outlining example processing steps taken by an element according to one embodiment of the present invention;

FIG. 3 is a flow diagram outlining example processing steps taken by an element according to one embodiment of the present invention;

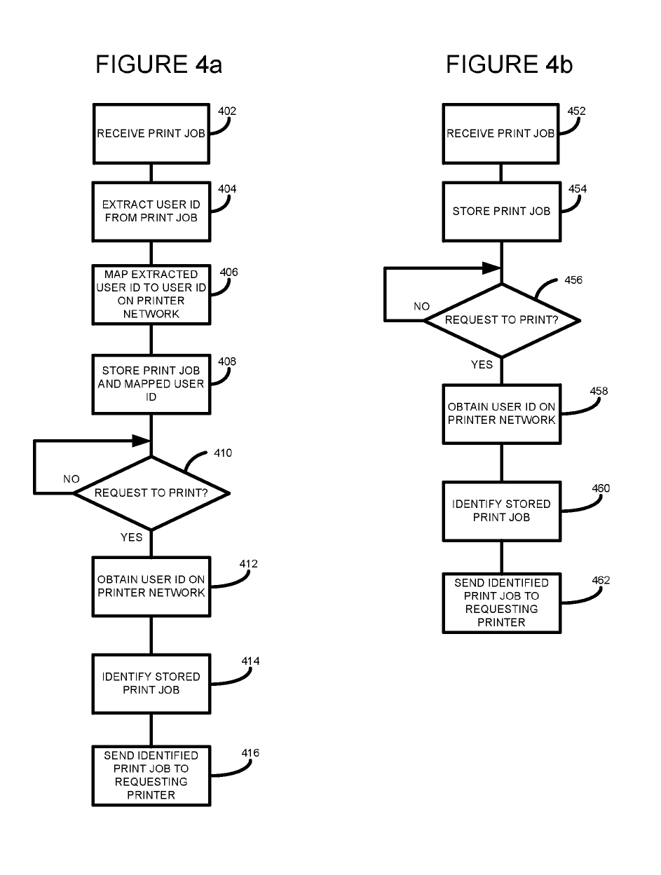

FIG. 4a is a flow diagram outlining example processing steps taken by a element according to one embodiment of the present invention; and

FIG. 4b is a flow diagram outlining example processing steps taken by an element according to one embodiment of the present invention.

### DETAILED DESCRIPTION

Referring now to FIG. 1 there is shown a system 100 according to an embodiment of the present invention.

The system 100 shows an enterprise network arrangement of an enterprise having three separate and independent networks 102a, 102b, and 102c. By separate and independent is meant that it is not generally possible to communicate between the different networks, for instance using a common network such as the Internet, Intranet, or the like. This separation may be appropriately achieved through hardware or software means, for example, through the physical design of each network, or by the configuration of one or more hardware or software elements in the network. This physical separation is used, for example, to ensure that a user authorized to only access data on a ‘confidential’ network is unable to access data on a ‘top secret’ network. In other embodiments, however, there may be some communication permitted between different networks.

For example, network 102a may be classified as a ‘top secret’ network, network 102b may be classified as a ‘secret’ network, and network 102c may be classified as a ‘confidential network’. In FIG. 1 the reference numeral suffix ‘a’ is used to refer to an element of the network 102a, a suffix ‘b’ is used to refer to an element of the network 102b, and a suffix ‘c’ is used to refer to an element of the network 102c. Those skilled in the art will appreciate that in other situations a greater or lesser number of computer networks 102 may be provided.

Network 102a has a number of computing devices 104a connected thereto. The computing devices 104a may be, for example, desktop computers, laptop computers, notebook computers, net-book computers, smart-phones, and the like. Each computing device 104a is used by a user, and the user is identified to the computing device, as well as to the network 102a, through an appropriate login or authentication process. The user of each computing device 104a may therefore access services, such as printing services, provided by the network 102a to which the user is authorized to access.

When a user of a computing device 104a wants to print a document or other appropriate media, the computing device 104a creates a print job. The print job may comprise, for example, one or more files or other data containers containing the print code data to be printed. Those skilled in the art will appreciate that the print code data is data that describes what is to be printed to a printer. The print code data in the print job may be arranged or formatted in any suitable manner. Furthermore, the print job includes an identifier (user identifier) of the user who has been authenticated to use the computing device 104a.

The print job is sent to a network print server 106a, the address of which is appropriately known, available to, or configured in the computing device 104a.

Those skilled in the art will appreciate that the term ‘server’ used herein may be any suitable computing device having a processor coupled to a memory on which are stored processor executable instructions suitable for performing processing steps.

Rather than having a network printer network connected to the print server 106a, as in the prior art, the print server 106a is configured to forward the print job to a source server 108a. The source server 108a is configured to appear to the print server 106a as a printer.

In an alternative embodiment, the print server 106a and source server 108a may be combined into a single server (not shown) having substantially the combined functionality of both the print server 106a and the source server 108a, as described above.

Further reference will now be made to FIGS. 2, 3, 4a, and 4b.

The source server 108a receives (step 202) the print job from the print server 106a and is configured to forward (step 204) the print job over a communication link 110a. In the present embodiment the communication link 110a may be, for example, a unidirectional link or unidirectional network.

The communication link 110a provides access only in one direction to prevent unauthorized access from being gained to the network 102a through the communication link 110a. The communication link 110a may be suitably achieved, for example, using a fiber optic cable to which send and receive transceivers are not present in one direction. Alternatively, the communication link 110a may, for example, be a conventional link or network configured using appropriate hardware, firmware, or software, to allow access only in a single direction. The communication link 110a may, for example, comply with information technology security evaluation criteria (ITSEC) level E6 and Common Criteria Evaluation Assurance Level (CC EAL) level 7.

For example, the source server 108a may include only a fiber optic transmitter module, for sending data over a fiber optic cable forming the communication link, but not including a fiber optic receiver for receiving data over a fiber optic cable.

The communication link 110a thereby provides an effective security boundary 112.

A destination server 114a is connected to the communication link 110a to receive data sent by the source server 108a. For example, the destination server may include only a fiber optic receiver module for receiving data over a fiber optic cable, but not including a fiber optic transmitter module for sending data over a fiber optic cable.

The destination server 114a is connected to a print server 116. The connection may be made, for example, through a separate private network, or by a direct or other indirect network connection.

The destination server 114a receives (step 302) the print job sent by the source server 108a and is configured to forward (step 304) the print job to the print server 116 connected additionally to a printer network 118. The address of the print server to which to forward the print job may be suitably preconfigured in the destination server 114a, or may be obtained through an appropriate discovery mechanism.

The printer network 118 is configured as a ‘pull printer network’. In this way, print jobs sent for printing are not printed on any particular printer 120a to 120n on the printer network 118, but are stored in the print server 116 until they are actively retrieved by the user who instigated the printing of the print job, as described further below.

In the present embodiment, each user of the printer network 118 is assigned a unique user identifier on the printer network 118 (hereinafter referred to as a printer network user identifier). The print server 116 comprises a database 117 which may be either internal thereto, or accessible thereby. The database 117 is configured with a mapping from the user identifier of the user on the network 102a to a corresponding print network user identifier.

Example mappings from user identifiers of each of the networks 102a, 102b, and 102c to printer network user identifiers of printer network 118 are shown below. It should be noted that a single user may have a different user identifier on different ones of the networks 102a, 102b, and 102c. These different user identifiers are mapped to a single user identifier in the printer network, as shown below.

| USER ID NETWORK 1 | PRINTER NETWORK USER ID |
|---|---|
| topsecret/user1 | printnet/aa00 |
| topsecret/user2 | printnet/aa01 |
| topsecret/user3 | printnet/ab02 |
| topsecret/user4 | printnet/ad07 |

| USER ID NETWORK 2 | USER ID PRINTER NETWORK |
|---|---|
| secret/user1 | printnet/ba21 |
| secret/user2 | printnet/aa00 |
| secret/user3 | printnet/bb26 |
| secret/user4 | printnet/bk37 |

| USER ID NETWORK 3 | USER ID PRINTER NETWORK |
|---|---|
| conf/user1 | printnet/cl26 |
| conf/user2 | printnet/cg23 |
| conf/user3 | printnet/aa00 |
| conf/user4 | printnet/bb26 |

As shown in FIG. 4a, the print server 116 receives (step 402), for example at a processor, the print job from the destination server 114a and extracts (step 404), for example using the processor, from the print job the user identifier of the user on the network 102a who instigated the print job. The print server 116 then obtains (step 406), from the database 117, a corresponding printer network user identifier. The print server 116 then stores (step 408), for example using the processor, the print job and obtained printer network user identifier in a suitable storage medium, such as a hard drive, or other mass storage device. The user identifier of the user on the network 102a who instigated the print job may, in an alternative embodiment, also be stored with the print job.

When a user wishes to print a print job on a printer 120a to 120n the user identifies himself on the printer on which they wish the print job to be printed. For example, the user may identify himself by inputting his printer network user identifier using a user interface, such as a keypad, of the printer. Alternatively, the printer may be equipped with a smartcard, magnetic stripe or RFID, type card reader, or the like, from which the printer network user identifier may be read.

The chosen printer 120a to 120n then sends a ‘request to print’ message including the identified printer network user identifier to the print server 116. The print server 116 receives (step 410), for example at a processor, the request to print message and extracts (step 412) the printer network user identifier from the request message. The printer server 116 identifies (step 414), for example using the processor, any stored print jobs associated with the printer network user identifier and sends (step 416), for example using the processor, the identified print job or jobs to the printer that sent the request to print message. Where more than one print jobs are sent, the printer receiving the print jobs may suitably present the user with a choice of which print jobs to print, for example using a suitable user interface of the printer.

The chosen printer 120a to 120n then receives the print job and prints the print job in the normal manner.

In an alternative embodiment, shown in FIG. 4b, the print server 116 receives (step 452), for example at a processor, the print job from the destination server 114a and stores (step 454), for example using the processor, the received print job in a suitable storage medium, such as a hard drive, or other mass storage device. In this case, the stored print job includes the user identifier of the user on the network 102a who instigated the print job.

When a user wishes to print a print job on a printer 120a to 120n the user identifies himself on the printer on which they wish the print job to be printed, as described above.

The chosen printer 120a to 120n then sends a ‘request to print’ message including the identified printer network user identifier to the print server 116. The print server 116 receives (step 456), for example at a processor, the request to print message and extracts (step 458) the printer network user identifier from the request message. The printer server 116 identifies (step 460), for example using the processor, using the database 117 any stored print jobs associated with the printer network user identifier and sends (step 462), for example using the processor, the identified print job or jobs to the printer that sent the request to print message.

The chosen printer 120a to 120n then receives the print job and prints the print job in the normal manner.

In a further embodiment, the print server 106a to 106c and the print server 116 may be configured as Microsoft Windows printer servers, whereas the source servers 108a to 108c and destination servers 114a to 114c may be configured to execute an operating system other than Microsoft Windows, such as Linux.

In a yet further embodiment the source servers 108a to 108c and the destination servers 114a to 114c may additionally be configured to provide additional services and features, for example the obfuscation of usernames, adding watermarks to print jobs, logging, auditing and archiving print jobs.

The embodiments described herein provide a high security printing solution enabling a single printing network to be used with multiple independent networks. This not only removes the previously required duplication of printing infrastructure on each of the networks, but also provides an architecture which mitigates the risk of malicious attack by users or through malicious code originating on the user networks.

Those skilled in the art will appreciate that other alternative unidirectional links of networks may be provided.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1.-15. (canceled)

16. A system for printing from a first network to a printer connected to a second network comprising:
a first server on the first network for receiving a print job, the print job including print code data and user identification data identifying the user on the first network who initiated the print job, the first server configured to transmit the print job over a communication link;
a second server on the second network for receiving the print job and user identification data through the communication link;
a print server on the second network comprising a database mapping the user identification data of the user on the first network to a user identifier on the second network, and configured to:
receive the print job from the second server;
receive a request from a printer on the second network to print a print job, the request including an identifier of a user on the second network;
identify a received print job associated with the user identifier in the request; and
send the identified print job to the printer.

17. The system of claim 16, wherein the communication link is a unidirectional network.

18. The system of claim 16, wherein the first server is configured to receive the print job from a print server on the first network.

19. The system of claim 16, wherein the second server is configured to send the print job, the print job containing the print code data and the user identifier of the user on the first network.

20. The system of claim 16, wherein the second server is configured to send the print job, the print job containing the print code data and the printer network user identifier of the user identified in the request

21. The system of claim 16, further comprising, where a plurality of print jobs are identified, send all of the identified print jobs to the printer.

22. The system of claim 16, wherein the first and second networks are independent from one another.

23. The system of claim 16, wherein the communication link is a certified secure one way link or network.

24. The system of claim 16, wherein the communication link is a fiber optic cable, wherein the first server is configured to only be able to transmit data through the fiber optic cable and not to receive data therethrough, and wherein the second server is configured to only be able to receive data through the fiber optic cable and not to transmit data therethrough.

25. A method of printing from a first network to a printer connected to a second network comprising:
receiving, at a processor, a print job, the print job including print code data and data identifying a user on the first network;
transmitting, by the processor, the print job over a communication link;
receiving, at a print server on a second network, the print job from the second server through the communication link;
receiving, at the print server, a request, from a printer on the second network, to print a print job, the request including an identifier of a user on the second network;
identifying, at the print server, using a mapping database, a received print job associated with the user identified in the received request; and
sending the identified print job from the print server to the printer.

26. The method of claim 25, wherein the step of transmitting the print job over a communication link is arranged for transmitting the print job over a unidirectional communication link or network.

27. The method of claim 25, wherein the step of receiving a print job is arranged to receive the print job from a print server on the first network.

28. The method of claim 25, wherein the step of sending the print job to the printer comprises sending only print code data to the printer.

29. The method of claim 25, wherein the step of sending the print job of the printer comprises sending the print job containing the print code data and the user identifier of the user identified in the request.
